(19) United States
(12) Patent Application Publication
(10) Pub. No.: US 2013/0314201 A1
(43) Pub. Date: Nov. 28, 2013

(54) OVER-CURRENT PROTECTION FUSES

(71) Applicants: Tzye Perng Poh, Shah Alam Selangor (MY); Leng Hoo Tan, Singapore (SG); Kah Hoe Ng, Singapore (SG)

(72) Inventors: Tzye Perng Poh, Shah Alam Selangor (MY); Leng Hoo Tan, Singapore (SG); Kah Hoe Ng, Singapore (SG)

(21) Appl. No.: 13/478,239

(22) Filed: May 23, 2012

(51) Int. Cl. H01H 85/046; H01H 69/02

(52) U.S. Cl. 337/297; 29/623

(57) ABSTRACT

A method of forming a fusible link on a printed circuit board. The method comprises integrally forming a first end pad, a second end pad, and a fusible link between the first and the second end pads on the printed circuit board; wherein the cross-sectional area of the fusible link is smaller than that of the first and second end pads.

### BACKGROUND

Over-current protection fuses are commonly used to protect electronic or electrical devices from damage by over current. Over-current protection fuses (or fuses in short) are usually either of the disposal type or the re-usable type. Re-usable fuses typically comprise a switchable fuse link which would be automatically turned off when a current exceeding a threshold passes through the fuse link for a predetermined time. The fuse can be switched back to normal current passage operation by a user after the triggering event has disappeared. Circuit breakers are a common example of re-usable fuses. On the other hand, disposable or one-time fuses typically comprise a fusible link which melts when a threshold current passes through the fusible link for a predetermined time. Fuse bulbs comprising a fusible wire mounted and enclosed inside a glass tube with metallic contact terminals at its longitudinal ends are a common example of disposable fuses. Surface mountable fuse chips are another type of commonly known one-time fuse.
Electronic components of electronic devices or appliances which are vulnerable to over-current damage are commonly protected by on-board fuses. On board fuses are typically fuse bulbs which are detachably mounted on fuse brackets soldered on a printed circuit board. The fuse brackets facilitate convenient replacement of fuse bulbs when necessary.

### DESCRIPTION OF DRAWINGS

The present disclosure will be described by way of example below with reference to the accompanying drawings, in which:

FIG. 1 is a perspective view showing an example of an electronic device comprising an on-board fusible link,

FIG. 1A show a cross-sectional view taken along section A-A of FIG. 1,

FIG. 2 is a perspective view showing another example of an electronic device comprising an on-board fusible link and on-board fuse brackets, and

FIG. 3 shows the electronic device of FIG. 2 detachably mounted with a fuse bulb.

### DESCRIPTION OF EXAMPLES

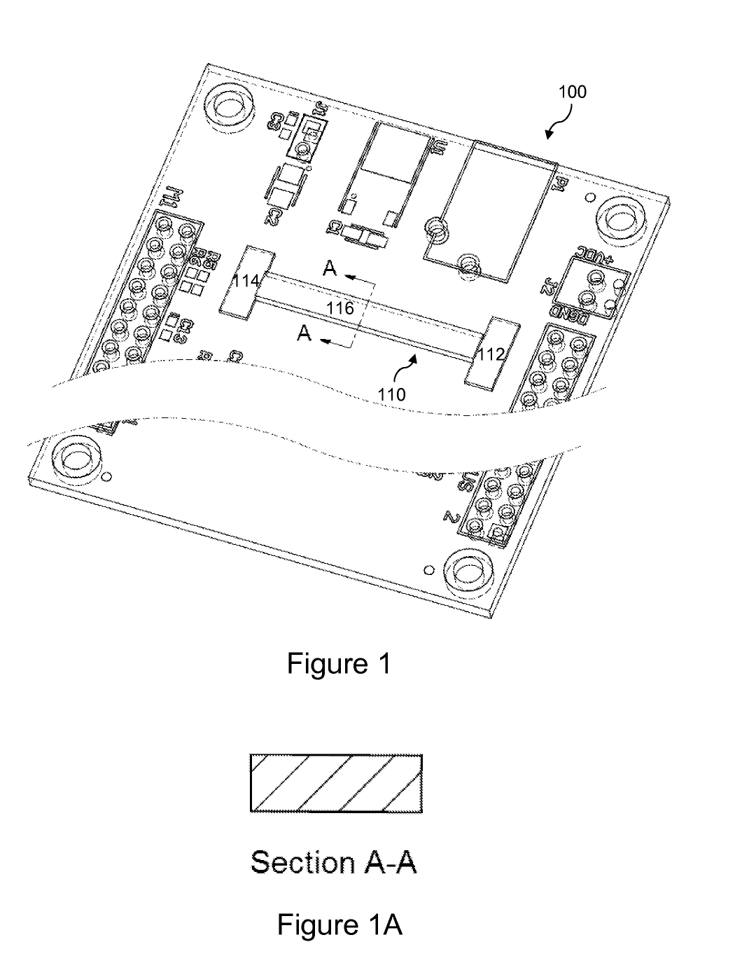

An electronic device such as a computer server, a network switch, routers, or forwarding device, comprises a printed circuit board 100 of FIG. 1. The printed circuit board comprises a number of printed circuit traces which are integrally formed on a insulating board substrate. The printed circuit traces may comprises a number of printed circuit pads and/or printed circuit tracks. In general, the printed circuit tracks are primarily elongate tracks which interconnect printed circuit pads. On the other hand, printed circuit pads can be soldering pads for receiving end terminals of electronic components such as integrated circuits and discrete components. In general, pads are wider than tracks. The discrete components can be passive components, active components, or hybrid components comprising both active and passive components. For example, pads labelled with the alphabet ‘R’ are for receiving terminal ends of chip resistors, while pads labelled with the alphabet ‘C’ are for receiving terminal ends of chip capacitors. In addition, the pads marked with the alphabet ‘J’ are jumper pads for jumper connection. For example, the jumper pads labelled with ‘J2’ are for connection to a direct current (DC) power source, and the power supply terminals are labelled with +VDC and DCGN to represent the positive and ground terminals respectively.

A printed fuse comprising a printed circuit track 110 is connected between the positive terminal +VDC of the power supply terminals and an electronic component which obtains power from the power supply and which is to be protected from over-current damage. The printed circuit track 110 comprises a first conductive pad 112, a second conductive pad 114, and a current fusible link 116 interconnecting the first and the second pads. The first conductive pad 112 is connected to the positive terminal of the power supply, while the second conductive pad 114 is connected to the first conductive pad 112 via the current fusible link 116. In order words, the first conductive pad 112 is upstream of the fusible link 116, and the second conductive pad 114 is downstream of the fusible link 116.

In this example, the first conductive pad 112, the second conductive pad 114, and the current fusible link 116 are integrally formed as a continuous copper trace on the printed circuit board. Although the copper trace is commonly referred to as a ‘printed’ trace, the copper trace is usually formed by etching of the copper surface of a copper plated circuit board in practice.

As depicted in FIGS. 1 and 1A, the width of the fusible link 116 is narrower than the width of the first 112 and second 114 pads to define a weakness interconnection between the first and the second pads. The cross sectional area of the fusible link is such that:

I=0.188A/t0.5

In the equation above, I is the amount of current in amperes that can be applied to a trace of copper having a cross sectional area A square mils for t seconds before the trace melts, and 1 mil (=1 mili inch) is equal to 1/1000th inch or 0.0254 mm.

As an example, where an over-current protection required is 20 A for 0.5 second, the cross-sectional area of the copper trace of the fusible link would be 78 mils. It will be appreciated that where the thickness of the end pads 112, 114 and the fusible link 116 are the same, the width of the fusible link is smaller than that of the end pads so that melting will occurred at the region between the end pads without damaging the end pads.

During operation, power will be supplied from the power source +VDC to the more expensive or vulnerable electronic component, such as a microprocessor or other integrated circuits downstream of the printed fuse 110. When a current exceeding the fuse rated current passed through the fusible link for a time exceeding the fuse rated time, the fusible link will reach a melting temperature which for copper is 1083 degrees Celcius.

In order that the electronic device can resume operation after a fuse melting event has been removed, the end pads 112, 114 may be configured as soldered pads and the separation distance between them are such that a surface mountable fuse chip can be mounted on the end pads 112, 114 and soldered thereon to provide a backup current path.

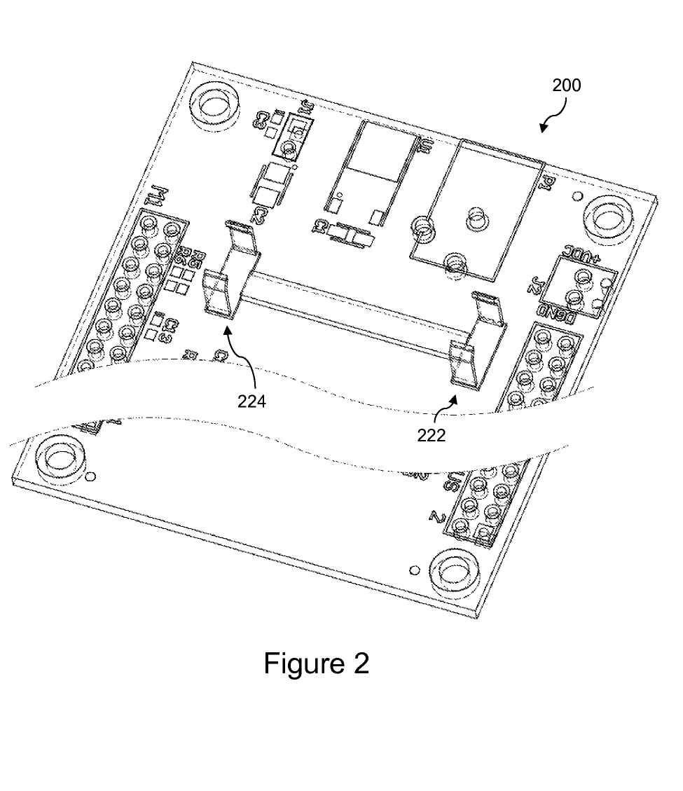

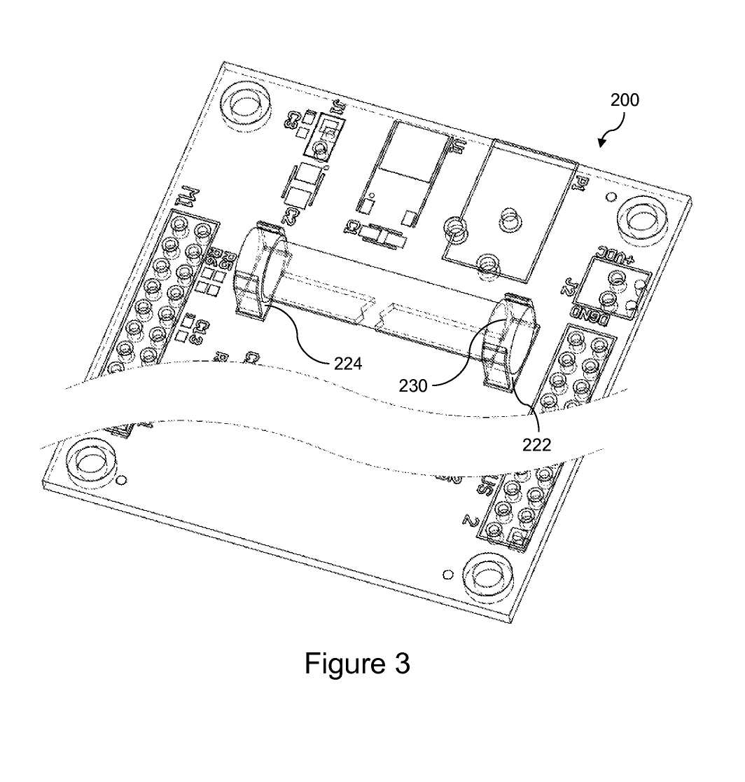

In another example of the electronic device 200 as shown in FIG. 2 provides fuse brackets 222, 224 which are mounted respectively at the first 112 and the second 114 pads. The fuse brackets are for detachably receiving a fuse bulb and the separation distance of the fuse brackets (and hence the separation of the end pads) is the same as the separation distance between the two metallic terminals 230 on the fuse bulb without loss of generality. The fuse brackets facilitate the establishment of a backup current path between the two end pads 112, 114 upon mounting of a fuse bulb on the fuse brackets as shown in FIG. 3 after the fusible link has been broken.

Therefore, there is provided an over-current protection fuse comprising a current fusible link which is deposited as a fusible track on an insulating substrate. As the fusible link is integrally formed on the substrate, and can be formed at the time when circuit traces of a printed circuit board are formed, material and assembly costs for mounting discrete fuses can be reduced.

An advantage of such an integrally formed fusible track as a built-in is that the fusible track can be enclosed between two layers of substrates, for example between two substrate layers of a multi-layered printed circuit board.

The insulating substrate may be made of alumina, silica, glass-polytetrafluoroethylene (PTFE), impregnated paper, woven fiber glass, or materials suitable for forming a printed circuit board.

The conductive material may be copper, aluminum or alloys.

The fusible link comprises a fusible track extending between two end pads, the fusible track having a cross sectional area that is smaller from the cross sectional area of the end pads. In addition or as an alternative, the fusible track may have a thickness that is smaller than the thickness of the two end pads.

In the above examples, printed circuit boards having printed copper traces have been used as an example. It will be appreciated that the printed circuit board can be coated with other conductive materials without loss of generality, and the current-time-area will be adjusted according to the melting characteristics of the particular conductive material. Furthermore, while a fuse bulb and a chip fuse have been used as examples disposal fuses, it will be appreciated that other types of fuses, whether disposable or reusable, can be mounted at the end pads and used to provide a backup current path whenever necessary or desirable.

1. An over-current protection fuse comprising a current fusible link deposited on an insulating substrate.

2. An over-current protection fuse according to claim 1, wherein the fusible link is a fuse track extending between two end pads which are deposited on the insulating substrate, and the width of the fuse track being smaller than that of the end pads.

3. An over-current protection fuse according to claim 2, wherein the two end pads are spaced such that end terminals of a discrete fuse device are mountable or solderable on the two end pads to provide a backup current path between the two end pads.

4. An over-current protection fuse according to claim 3, wherein conductive brackets for detachably mounting a discrete fuse are formed on the two end pads, the discrete fuse providing a backup current path between the two end pads when mounted on the conductive brackets.

5. An over-current protection fuse according to claim 1, wherein the insulating substrate is made of alumina, silica, glass-polytetrafluoroethylene (PTFE), impregnated paper, woven fiber glass, or materials suitable for forming a printed circuit board.

6. An over-current protection fuse according to claim 1, wherein the fusible link is integrally formed on a printed circuit board.

7. An over-current protection fuse according to claim 6, wherein the fusible link is formed as an integral part of printed circuit traces on the printed circuit board.

8. An over-current protection fuse according to claim 6, wherein the fusible link comprises a fusible track extending between two end pads, the fusible track having a cross sectional area that is smaller from the cross sectional area of the end pads.

9. An over-current protection fuse according to claim 6, wherein the fusible link comprises a fusible track extending between two end pads, the fusible track having a thickness that is smaller than the thickness of the two end pads.

10. An over-current protection fuse according to claim 6, wherein the fusible link provides serial electrical connection between first and second printed end portions on the printed circuit board, and wherein first and second fuse mounting brackets are provided respectively on the first and second printed end portions for receiving end terminals of a discrete fuse, and wherein a current path is established between the first and second printed end portions when a discrete fuse is mounted on the fuse mounting brackets after the fusible link between the first and second printed electronic circuit portions has broken.

11. An over-current protection fuse according to claim 6, wherein the fusible link is between layers of printed circuit board substrate.

12. A printed circuit board comprising an over-current protection fuse according to claim 1.

13. An electronic apparatus comprising a printed circuit board according to claim 12.

14. A method of forming a fusible link on a printed circuit board, the method comprising integrally forming a first end pad, a second end pad, and a fusible link between the first and the second end pads on the printed circuit board; wherein the cross-sectional area of the fusible link is smaller than that of the first and second end pads.

15. A method according to claim 14, wherein the fusing properties of the fusible link is I=0.188A/t^{0.5}, where I is the fusing current rating, A is the cross sectional area in mils, and t is the time to melt.
